(19) United States
(12) Patent Application Publication
(10) Pub. No.: US 2024/0376015 A1
(43) Pub. Date: Nov. 14, 2024

(54) CATALYTIC REFRACTORY HEATING APPLIANCE

(71) Applicant: DE.MISSION INC., Calgary (CA)

(72) Inventor: Kenneth Arnold LAWTON, Edmonton (CA)

(73) Assignee: DE.MISSION INC., Calgary, AB (CA)

(21) Appl. No.: 18/686,808

(22) PCT Filed: Aug. 24, 2022
(86) PCT No.: PCT/CA2022/051283

§ 371 Date: Feb. 26, 2024

(30) Foreign Application Priority Data
Aug. 26, 2021 (CA) 3129000

(51) Int. Cl. C04B 35/565; C04B 41/50; C04B 41/87; C04B 41/89; C04B 111/00

(52) U.S. Cl. CPC C04B 35/565; C04B 41/5029; C04B 41/87; C04B 41/89; C04B 2111/00267; C04B 2111/00431; C04B 2111/00482; C04B 2111/0081

(57) ABSTRACT

A catalytic refractory heating appliance includes a body formed from a silicon carbide refractory material having a porosity that permits ionic oxygen to pass through the refractory material. The body defines a gas flow channel. A catalyst coating is on a surface of the refractory material of the body, whereby the refractory material becomes an active component with catalytic capability. For example, when the catalytic refractory heating appliance is a fire tube carbon dioxide and sulfur compounds can be directly absorbed, or carbon monoxide is reduced to methane.

### CROSS-REFERENCE TO RELATED APPLICATIONS

This application claims the benefit of and claims priority to Canadian Patent Application No. 3,129,000 filed on 26 Aug. 2021.

Each of the aforementioned applications is incorporated by reference herein in its entirety, and each is hereby expressly made a part of this specification.

### TECHNICAL FIELD

The disclosure relates to appliances into which a catalytic refractory material has been incorporated and, in particular, to appliances where the catalytic refractory material can be used in a fire tube and other heating appliances.

### BACKGROUND

The term “refractory” means “resistant to a process or stimulus”. The purpose of the refractory material in a combustion heating appliance is to reduce heat loss and protect the interior structure from the chemistry of combustion. There are many different chemical compositions including calcium silicon, calcium and magnesium oxides, for example, that are formed into blocks and structures that are designed to withstand extreme temperatures for long operational periods without breaking down.

Cement like blocks of refractory material line the interiors of boilers and furnaces where fuels are consumed for process heating purposes. These solid materials serve the critical purpose of protecting the underlying metal structures from breakdown during prolonged operation at high temperatures. The shapes of these materials are further engineered to provide control of burner flame anchoring and to direct the flow of combustion gases within these appliances.

A characteristic of effective refractory material is the prevention of heat flux. Using a combination of highly stable nitride bonded silicon carbide structural elements cast to form the structure of the appliance while forming a refractory material provides utility. A catalytic coating applied to the refractory materials provides a catalytic refractory that induces desired chemical reactions inside the appliance that would otherwise not occur.

The catalytic converter in modern vehicles is a device which uses a ceramic core impregnated with rare earth metals forming a catalyst. While hot the catalyst induces reactions with carbon monoxide and nitrogen oxides to produce nitrogen and carbon dioxide. The catalyst and the physical converter are expensive to replace yet effective at reducing automobile emissions. A catalyst is something which induces a reaction yet is not consumed in the process.

The refractory inside a heating appliance is a static physical object which serves a critical purpose. Since the material is hot it provides the opportunity to introduce catalytic material applied to the refractory to induce desired chemical reactions inside the appliance.

### SUMMARY

There is provided a catalytic refractory heating appliance includes a body formed from a silicon carbide refractory material having a porosity that permits ionic oxygen to pass through the refractory material. The body defines a gas flow channel. A catalyst coating is on a surface of the refractory material of the body, whereby the refractory material becomes an active component with catalytic capability.

Nitride bonded silicon carbide material withstands extreme heat and does not disintegrate when exposed to oxygen. Due to the firing process the resulting silicon carbide material has a porosity that permits ionic oxygen to pass through the refractory materials. By modifying the porosity of the refractory and coating the surface of the refractory with a catalyst, the refractory becomes an active component with catalytic capability. For example, a fire tube can be coated with a metal oxide framework (MOF) catalyst whereby carbon dioxide and sulfur compounds can be directly absorbed, or carbon monoxide is reduced to methane.

In an aspect, the disclosure describes a catalytic refractory heating appliance. The catalytic refractory heating appliance also includes a body formed from a silicon carbide refractory material having a porosity that permits ionic oxygen to pass through the refractory material, the body defining a gas flow channel; and a catalyst coating a surface of the refractory material of the body, whereby the refractory material becomes an active component with catalytic capability.

Implementations may include one or more of the following features. The catalytic refractory heating appliance wherein the body is tubular. The body is a fire tube. The body is formed of conductive nitride-bonded silicon carbide refractory material. The catalyst coating is a metal oxide framework catalyst. The catalyst coating is a metal oxide framework of calcium and magnesium oxide layers interconnected with an iron oxidation pathway for oxygen. The catalyst coating is a dolomitic limestone whitewash. A metallic vapor coating is positioned on the silicon carbide refractory material. The metal vapor coating is combined with the catalyst coating. The metal vapor coating is comprised of a majority of lead sulfide with bismuth trioxide.

In an aspect, the disclosure describes a catalytic refractory heating appliance. The catalytic refractory heating appliance also includes a body formed from a conductive nitride-bonded silicon carbide refractory material having a porosity that permits ionic oxygen to pass through the refractory material, the body being tubular and defining a gas flow channel; and a metal oxide framework catalyst coating a surface of the refractory material of the body, whereby the refractory material becomes an active component with catalytic capability.

Implementations may include one or more of the following features. The catalytic refractory heating appliance wherein the metal oxide framework catalyst coating is of calcium and magnesium oxide layers interconnected with an iron oxidation pathway for oxygen. A metal vapor coating is combined with the metal oxide framework catalyst coating. The metal vapor coating is comprised of a majority of lead sulfide with bismuth trioxide.

Embodiments can include combinations of the above features.

Further details of these and other aspects of the subject matter of this application will be apparent from the detailed description included below and the drawings. These and other features will become more apparent from the following description in which reference is made to the appended drawings, the drawings are for the purpose of illustration only and are not intended to be in any way limiting.

### DESCRIPTION OF THE DRAWINGS

Reference is now made to the accompanying drawings, in which:

FIG. 1 is a depiction of a crystal structure of calcite; and

FIG. 2 is a depiction of a crystal structure of dolomite; and

FIG. 3 is a perspective view of a tubular body of catalytic refractory material; and

FIG. 4 is a side elevation view of the tubular body of FIG. 3 incorporated into a catalytic refractory heating appliance.

### DETAILED DESCRIPTION

Aspects of various embodiments are described in relation to the figures.

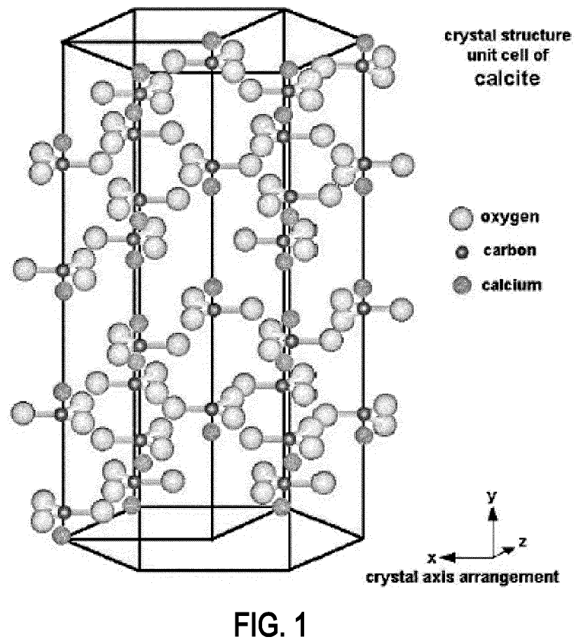

A catalytic refractory, generally identified by reference numeral 10, will now be described with reference to FIG. 1 through FIG. 4.

### Structure and Relationship of Parts

Nitride bonded silicon carbide material withstands extreme heat and does not disintegrate when exposed to oxygen. Due to the firing process the resulting silicon carbide material has a porosity that permits ionic oxygen to pass through the refractory materials. By modifying the porosity of the refractory and coating the surface of the refractory with a catalyst, the refractory becomes an active component with catalytic capability. For example, a fire tube can be coated with a metal oxide framework (MOF) catalyst whereby carbon dioxide and sulfur compounds can be directly absorbed, or carbon monoxide is reduced to methane.

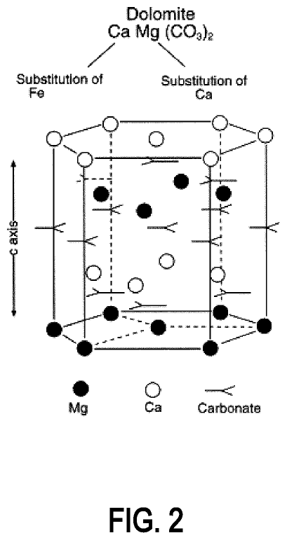

Referring to FIG. 1, a typical natural limestone or the calcium carbonate is calcined to form calcite, a refractory material. Naturally occurring limestone deposits exposed to magnesium rich water over time form a different material known as dolomitic limestone, shown in FIG. 2. Dolomite refractories mainly consist of calcium magnesium carbonate. Typically, dolomite refractories are used in converter and refining furnaces. FIG. 2 shows Ca(Mg, Fe)(CO₃)₂.

A variation in the dolomitic limestone containing calcium magnesium carbonate forms when iron carbonate is added prior to calcining to form a metal oxide framework of calcium and magnesium oxide layers interconnected with an iron oxidation pathway for oxygen. This catalyst has been demonstrated to reduce up to 80 percent of the carbon dioxide to carbon monoxide while the oxygen oxidizes the iron.

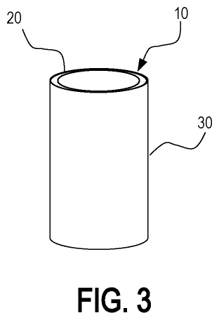

Referring to FIG. 3, catalytic refractory 10 consists of a nitride bonded silicon carbide body 20, coated with a MOF catalyst coating of dolomitic limestone whitewash (MOF catalyst 30), and calcined at 700° C. for 20 minutes and then cooled for a 20-minute cooling period. As will hereinafter be described, catalytic refractory 10 is engineered to define a gas flow channel for secondary heat recovery to preheat combustion air. Maximum efficiency is obtained in secondary heat recovery incorporating these refractory elements.

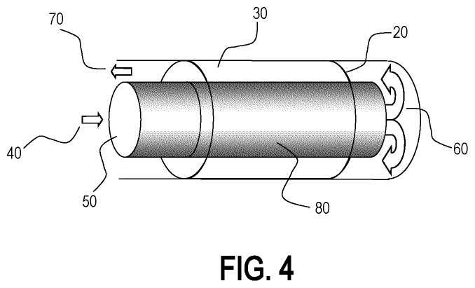

Referring to FIG. 4, hydrocarbon fuel 40 is fed into catalytic refractory heating appliance 50, into which has been incorporated the catalytic refractory 10. When the hydrocarbon fuel is ignited, hot carbon dioxide 60 enters the pore space of the MOF catalyst 30, in a manner similar to the manner in which carbon dioxide is received by leaves on a tree. Carbon dioxide 60 dissociates into carbon monoxide 70 and an oxygen ion. The oxygen ion bonds with the iron forming iron oxide while the carbon monoxide leaves the MOF catalyst 30.

When heating appliance 50 is shut down, catalytic refractory 10 cools. As MOF catalyst 30 cools it continues to adsorb carbon dioxide from the atmosphere provided the humidity is above a minimum % relative humidity (RH). Regeneration of catalytic refractory 10 coated with MOF catalyst 30 occurs each cycle upon reheating the appliance. In order to increase the number of regeneration cycles and therefore the longevity of MOF catalyst 30, the electrons required to reduce the iron oxide are supplied by a metallic vapor coating 80, between the MOF and the conductive nitride bonded silicon carbide structure. This metal vapor coating consists of a base material consisting of a majority of lead sulfide and bismuth trioxide combined with the dolomitic limestone and iron carbonate prior to calcining the applied whitewash coating.

The embodiments described in this document provide non-limiting examples of possible implementations of the present technology. Upon review of the present disclosure, a person of ordinary skill in the art will recognize that changes may be made to the embodiments described herein without departing from the scope of the present technology. Practical implementation of the features may incorporate a combination of some or all of the aspects, and features described herein should not be taken as indications of future or existing product plans.

What is claimed is:

1. A catalytic refractory heating appliance, comprising:
a body formed from a silicon carbide refractory material having a porosity that permits ionic oxygen to pass through the refractory material, the body defining a gas flow channel; and
a catalyst coating a surface of the refractory material of the body, whereby the refractory material becomes an active component with catalytic capability.

2. The catalytic refractory heating appliance of claim 1, wherein the body is tubular.

3. The catalytic refractory heating appliance of claim 2, wherein the body is a fire tube.

4. The catalytic refractory heating appliance of claim 1, wherein the body is formed of conductive nitride-bonded silicon carbide refractory material.

5. The catalytic refractory heating appliance of claim 1, wherein the catalyst coating is a metal oxide framework catalyst.

6. The catalytic refractory heating appliance of claim 1, wherein the catalyst coating is a metal oxide framework of calcium and magnesium oxide layers interconnected with an iron oxidation pathway for oxygen.

7. The catalytic refractory heating appliance of claim 6, wherein the catalyst coating is a dolomitic limestone whitewash.

8. The catalytic refractory heating appliance of claim 1, wherein a metallic vapor coating is positioned on the silicon carbide refractory material.

9. The catalytic refractory heating appliance of claim 8, wherein the metal vapor coating is combined with the catalyst coating.

10. The catalytic refractory heating appliance of claim 9, wherein the metal vapor coating is comprised of a majority of lead sulfide with bismuth trioxide.

11. A catalytic refractory heating appliance, comprising:
a body formed from a conductive nitride-bonded silicon carbide refractory material having a porosity that permits ionic oxygen to pass through the refractory material, the body being tubular and defining a gas flow channel; and
a metal oxide framework catalyst coating a surface of the refractory material of the body, whereby the refractory material becomes an active component with catalytic capability.

12. The catalytic refractory heating appliance of claim 11, wherein the metal oxide framework catalyst coating is of calcium and magnesium oxide layers interconnected with an iron oxidation pathway for oxygen.

13. The catalytic refractory heating appliance of claim 11, wherein a metal vapor coating is combined with the metal oxide framework catalyst coating.

14. The catalytic refractory heating appliance of claim 13, wherein the metal vapor coating is comprised of a majority of lead sulfide with bismuth trioxide.
